(19) United States
(12) Patent Application Publication
(10) Pub. No.: US 2003/0177328 A1
(43) Pub. Date: Sep. 18, 2003

(54) Method and apparatus for controlling stack area in memory space

(75) Inventors: Masayuki Naganuma, Kawasaki (JP); Takeshi Eto, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/386,709

(22) Filed: Mar. 13, 2003

(30) Foreign Application Priority Data
Mar. 18, 2002 (JP) 2002-074732

(51) Int. Cl. G06F 12/00

(52) U.S. Cl. 711/170

(57) ABSTRACT

A method of controlling stacks includes providing a temporal stack area in advance in a predetermined memory area, allocating the temporal stack area as a continuation of a current stack area in response to detection of overflow of the current stack area in main memory space, and executing a stack expansion process with respect to the current stack area by setting aside a new stack area by use of the temporal stack area as a work area.

### CROSS-REFERENCE TO RELATED APPLICATIONS

The present application is based upon and claims the benefit of priority from the prior Japanese Patent Application No. 2002-074732 filed on Mar. 18, 2002, with the Japanese Patent Office, the entire contents of which are incorporated herein by reference.

### BACKGROUND OF THE INVENTION

1. Field of the Invention

The present invention generally relates to a method and apparatus for controlling the memory space of a computer, and particularly relates to a method and apparatus for controlling the stack memory space used in a stack machine architecture.

2. Description of the Related Art

The stack machine architecture stores control information and the like such as operands, functions, local variables, parameters, return values, stack frames, etc., in stacks provided in the memory space. Such stack machine architecture can be easily implemented by use of a relatively simple structure, and, thus, tends to be implemented as a virtual machine that is software built on register-architecture hardware.

In order to prevent a system from sustaining fatal damage caused by a program of a malicious intent at the time of receiving the program through a network, a virtual machine may be utilized as an intermediary that serves as reinforcement against attack from the outside. The virtual machine acts as an intermediary by receiving a program sent from the outside and by denying access to a critical portion of the system, thereby protecting the system. Such a virtual machine can easily be implemented based on a stack machine architecture as is well known through the example of a Java virtual machine.

In recent years, the stack machine architecture has often been implemented directly as hardware having the stack machine architecture, the purpose being the faster execution of programs, the implementation of an operating environment in such a form as to save resources, etc.

In practice, it is difficult to allocate stacks as an infinite continuous area in the memory space or as an infinite continuous area through hardware implementation. Therefore, a limited area of memory space is allocated first. Since the size of stacks that is going to be necessary cannot be known at the time of allocation of the stack area, a predetermined area of memory space is set aside in the memory. As data processing thereafter proceeds, stack frames are successively stacked one over another. When an additional area is to be used as stacks in excess of the initially allocated area, a new stack area needs to be further allocated. This state is referred to as a stack overflow.

In a system that implements multithread or multitask operations, a plurality of processes are simultaneously performed through timesharing. Threads or tasks are not in synchronization with each other, and each thread or task uses a stack area of its own independently of each other. Accordingly, each thread or task needs to keep a separate stack area dedicated for its own use. Since there are a plurality of threads or tasks and the size of the main memory is limited, it is not possible to set aside a sufficient memory area as a stack area by taking into account a maximum memory area that is to be needed by each thread or task. Because of this, it is unavoidable to have a stack overflow.

At the onset of stack overflow, a stack expansion process for expanding the stack area is carried out so as to insure continuation of processing. The stack expansion process tries to find a large contiguous area available in the main memory, and moves the contents of the stacks accumulated before the occurrence of stack overflow to the newly allocated stack area. Also, the stack expansion process divides a stack comprised of a plurality of stack frames into stacks having proper size. Since the stack expansion process is carried out by using stack areas in the same manner as routine and ordinary program processes, there is a need to provide a stack area as a work area for use by the stack expansion process.

In conventional schemes, a work area for use by the stack expansion process is secured by setting aside a portion of the currently allocated stack area. That is, an ending portion of the stack area that is currently allocated is set aside as a work area, and the stack expansion process is performed at the time of stack overflow that is detected when the stack area other than the allocated work area is used up. In this case, a new stack area is to be allocated for use as a stack area for the continuing processing and for use as a work area used by the stack expansion process.

In the case of multithread or multitask operations, each thread or task has its own stack area independently of each other, as previously described. Assuming that the number of threads or tasks is n, n work areas for use by stack expansion processes are always kept in the memory regardless of whether such work areas are going to be actually needed. This is not preferable in terms of efficient use of the main memory that is limited resources of the system.

Accordingly, there is a need for a method and apparatus for controlling stack areas that can perform a stack expansion process through effective use of work areas.

### SUMMARY OF THE INVENTION

It is a general object of the present invention to provide a method and apparatus that substantially obviates one or more of the problems caused by the limitations and disadvantages of the related art.

Features and advantages of the present invention will be set forth in the description which follows, and in part will become apparent from the description and the accompanying drawings, or may be learned by practice of the invention according to the teachings provided in the description. Objects as well as other features and advantages of the present invention will be realized and attained by a method and apparatus particularly pointed out in the specification in such full, clear, concise, and exact terms as to enable a person having ordinary skill in the art to practice the invention.

In order to achieve these and other objects of the invention as broadly described herein, a method of controlling stacks includes providing a temporal stack area in advance in a predetermined memory area, allocating the temporal stack area as a continuation of a current stack area in response to detection of overflow of the current stack area in main memory space, and executing a stack expansion process with respect to the current stack area by setting aside a new stack area by use of the temporal stack area as a work area.

In the method as described above, when overflow occurs with respect to a currently performed process that uses the current stack area, address conversion is performed to allocate the temporal stack area as a continuation of the current stack area wherein the temporal stack area is provided in the main memory space or another memory space. When the memory space is viewed from the CPU, the current stack area and the temporal stack area are continuous in the logical address space. After the allocation of the temporal stack area, the stack expansion process is performed by using the temporal stack area as a work area. This eliminates a need to set aside a work area within the stack area for use by the stack expansion process as in the related art. Further, since each process is allowed to use the temporal stack area in turn each time a stack overflow occurs. Because of this, a single temporal stack area may be sufficient for shared use by a plurality of processes through timesharing. The stack expansion process can thus be performed by making efficient use of the work area.

According to another aspect of the invention, an information processing apparatus includes a main memory unit which provides main memory space, an execution unit which executes a process by using a current stack area provided in the main memory space, and an address conversion unit which allocates a temporal stack area as a continuation of the current stack area in response to detection of overflow by said execution unit when the overflow occurs with respect to the current stack area, wherein said execution unit uses the temporal stack area as a work area in order to set aside a new stack area by carrying out a stack expansion process with respect to the current stack area.

The provision of the address conversion unit for conversion between the physical address and the logical address makes it possible to allocate the temporal stack area as a continuation of the current stack area wherein the temporal stack area is situated in the main memory space or another memory space. There is thus no need to set aside a work area within the stack area for use by the stack expansion process as in the related art. Further, a single temporal stack area may be sufficient for shared use by a plurality of processes through timesharing. The stack expansion process can thus be performed by making efficient use of the work area.

Other objects and further features of the present invention will be apparent from the following detailed description when read in conjunction with the accompanying drawings.

### BRIEF DESCRIPTION OF THE DRAWINGS

FIG. 1 is an illustrative drawing for explaining the principle of the present invention for controlling stack areas;

FIG. 2 is an illustrative drawing showing the way a temporal stack area is allocated as a continuation of a current stack area through address conversion;

FIG. 3 is an illustrative drawing showing a temporal stack area situated in the main memory space;

FIG. 4 is a block diagram showing a configuration by which the temporal stack area is allocated in the main memory space as shown in FIG. 3;

FIG. 5 is an illustrative drawing showing an example in which the temporal stack area is allocated in the main memory space;

FIG. 6 is an illustrative drawing showing an example in which the current stack area is controlled by a current stack pointer;

FIG. 7 is an illustrative drawing for explaining the relocation of the current stack area by use of the current stack pointer;

FIG. 8 is an illustrative drawing showing a configuration by which the temporal stack area is provided in another memory space different from the main memory space;

FIG. 9 is a block diagram showing a construction by which the temporal stack area is implemented by use of a temporal stack register;

FIG. 10 is a block diagram showing a construction in which a cache is employed when the high-speed register serving as a temporal stack register has insufficient size; and

FIG. 11 is an illustrative drawing showing memory space in which a temporal stack register is mapped through association control.

### DESCRIPTION OF THE PREFERRED EMBODIMENTS

In the following, embodiments of the present invention will be described with reference to the accompanying drawings.

In the present invention, a work area for use by a stack expansion process is not set aside in the currently allocated stack area. When all the stack area is used up, a stack expansion process is carried out as a response to the stack overflow detection by using a work area that is set aside in the memory space of the main memory or another memory space. When the stack expansion process is completed, and moving to a new stack area is finished, the work area for use by stack expansion processes is available for use by the stack expansion process of another thread or task. This work area for use by stack expansion processes is referred to as a temporal stack area.

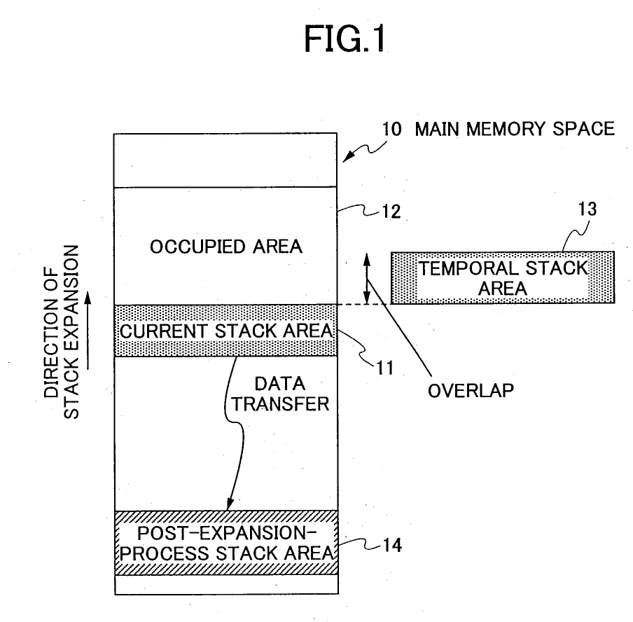

FIG. 1 is an illustrative drawing for explaining the principle of the present invention for controlling stack areas.

In FIG. 1, main memory space 10 includes a current stack area 11 that is allocated as a stack area for a single process (or either thread or task) being currently processed. In the main memory space 10, other stack areas may be provided for a plurality of processes as the current stack area 11. In FIG. 1, as the contents of the stack increases in response to the carrying out of the process, the stack expands upwards.

FIG. 1 shows a situation in which an occupied area 12 being currently in use is situated in the way of the current stack area 11 that is expanding. The occupied area 12 may store therein data of processes other than the process corresponding to the current stack area 11, and cannot be intruded by this currently performed process.

When stack overflow occurs with respect to the currently performed process using the current stack area 11, a temporal stack area 13 set aside in the main memory space or another memory space is allocated as a continuation of the current stack area 11. This allocation is performed through address conversion.

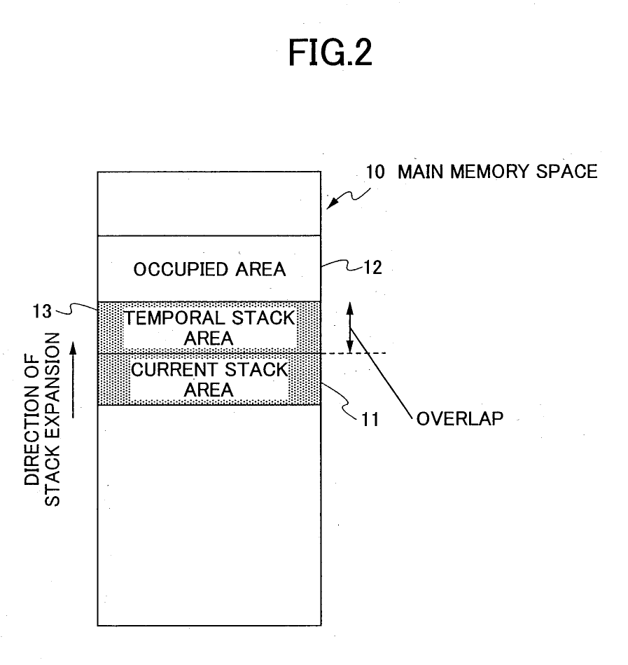

FIG. 2 is an illustrative drawing showing the way the temporal stack area 13 is allocated as a continuation of the current stack area 11 through address conversion. When the memory space is viewed from the CPU, each area is situated as shown in FIG. 2, so that the no access can be made to the occupied area 12 overlapping the temporal stack area 13. Accordingly, the contents of the occupied area 12 will never be destroyed by the stack expansion process.

Once the temporal stack area 13 is allocated, the stack expansion process is carried out by using the temporal stack area 13. Namely, the stack expansion process attends to processing such as finding a large contiguous area available in the main memory, moving the contents of the stacks accumulated before the occurrence of stack overflow to the newly allocated stack area, dividing a stack comprised of a plurality of stack frames into stacks having proper size, etc.

When a contiguous memory area larger than the current stack area 11 is to be set aside in the main memory space 10, a new stack area is allocated as shown as a post-expansion-process stack area 14 in FIG. 1. The contents of the current stack area 11 are then moved to the post-expansion-process stack area 14, which is subsequently used as a current stack area.

The post-expansion-process stack area 14 does not have to a physically contiguous area in the physical memory space as long as it is a contiguous area in the logical space. The post-expansion-process stack area 14 may have a chain structure that puts together a plurality of available areas by a list. The contents of the stack may be move to the new stack area. Alternatively, a memory control mechanism controls addresses in such a manner as to place the new stack area as a continuation of the current stack area 11.

After the completion of the stack expansion process, the allocation of the temporal stack area 13 comes to an end, thereby allowing access to be made to the occupied area 12 next to the current stack area 11. Subsequently, access can be made to the occupied area 12 as a routine matter.

In the manner as described above, a stack expansion process can be carried out by using the temporal stack area 13 as a work area even if the occupied area 12 is situated next to the current stack area 11 at the time of overflow in such a way as to obstruct the expansion of the current stack area 11. Accordingly, there is no need to set aside a work area in the stack area for use by a stack expansion process. Further, each process is allowed to use the temporal stack area 13 in turn each time a stack overflow occurs. Because of this, a single temporal stack area 13 may be sufficient for shared use by a plurality of processes through timesharing. A stack expansion process can thus be performed by making efficient use of the work area.

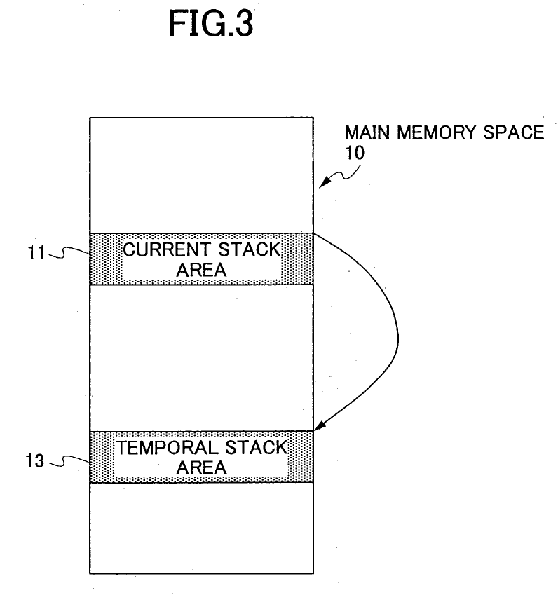

FIG. 3 is an illustrative drawing showing a temporal stack area situated in the main memory space.

When stack overflow occurs, address conversion is performed so as to place the temporal stack area 13 as a continuation of the current stack area 11. As previously described, the memory space appears as shown in FIG. 2 when viewed by the CPU.

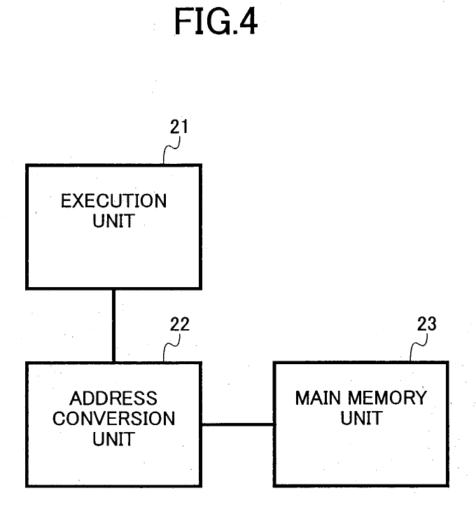

FIG. 4 is a block diagram showing a configuration by which the temporal stack area is allocated in the main memory space as shown in FIG. 3.

As shown in FIG. 4, an address conversion unit 22 is located between an execution unit 21 and a main memory unit 23. The address conversion unit 22 converts addresses between the logical address used by the execution unit 21 and the physical address of the main memory unit 23.

When the stack overflow occurs, the execution unit 21 sends a stack overflow notice to the address conversion unit 22. In response, the address conversion unit 22 converts addresses such as to link the temporal stack area 13 to the current stack area 11. Here, the temporal stack area 13 is a portion of the main memory space 10 of the main memory unit 23.

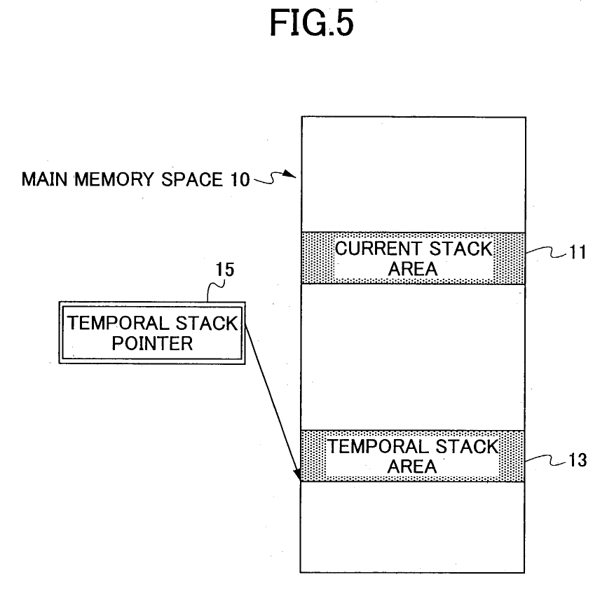

FIG. 5 is an illustrative drawing showing an example in which the temporal stack area is allocated in the main memory space.

In FIG. 3, the temporal stack area 13 may be fixed to a predetermined address. In FIG. 5, on the other hand, a temporal stack pointer 15 stores a pointer that points to the temporal stack area 13 (i.e., the address of the temporal stack area 13). This configuration allows the temporal stack area 13 to be moved inside the main memory space 10 according to the system need.

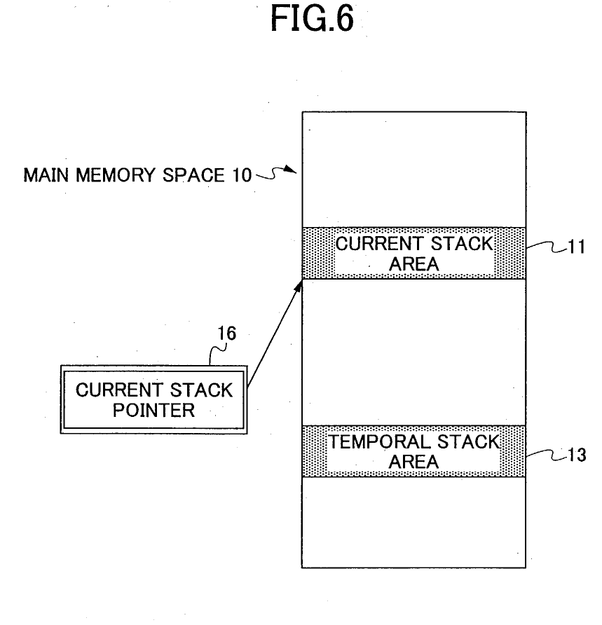

FIG. 6 is an illustrative drawing showing an example in which the current stack area is controlled by a current stack pointer.

In FIG. 6, a current stack pointer 16 stores a pointer that points to the current stack area 11 (i.e., the address of the current stack area 11). After all the contents of the stack are moved to the temporal stack area or to the post-expansion-process stack area through a stack expansion process, the position of the current stack area 11 can easily be changed within the main memory space 10 by changing the pointer stored in the current stack pointer 16.

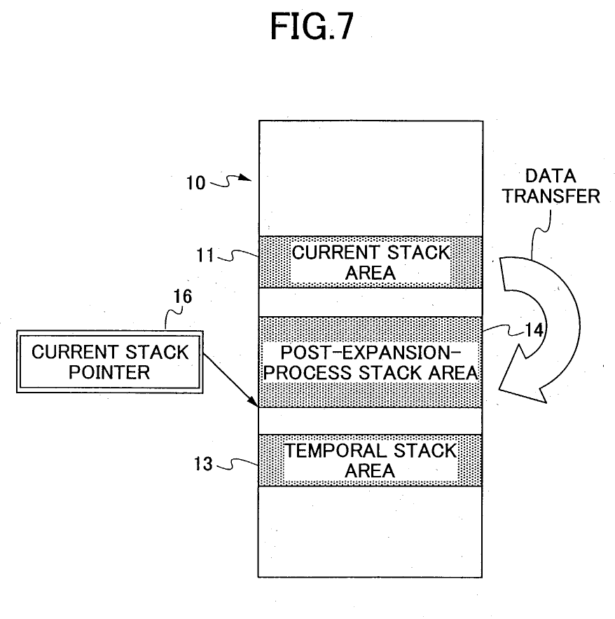

FIG. 7 is an illustrative drawing for explaining the relocation of the current stack area 11 by use of the current stack pointer 16.

As shown in FIG. 7, data stored in the current stack area 11 is transferred to the post-expansion-process stack area 14, followed by changing the pointer stored in the current stack pointer 16, thereby setting the current stack pointer 16 to point to the post-expansion-process stack area 14. Through this operation, the current stack area 11 is released, and the post-expansion-process stack area 14 will be used as a current stack area 11 in subsequent processing.

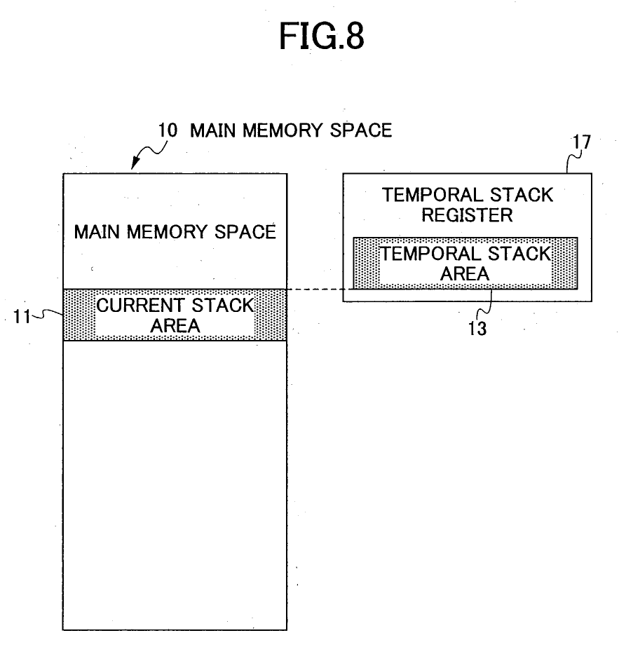

FIG. 8 is an illustrative drawing showing a configuration by which the temporal stack area is provided in another memory space different from the main memory space.

In FIG. 8, a temporal stack register 17 is provided for the purpose of implementing the temporal stack area 13. The provision of a high-speed register different from the main memory unit for the purpose of implementing the temporal stack area 13 makes it possible to carry out a stack expansion process at high speed.

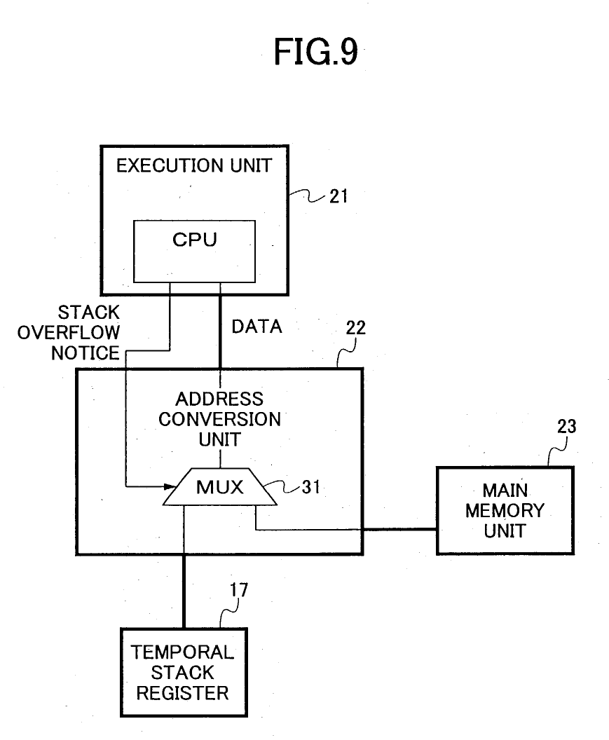

FIG. 9 is a block diagram showing a construction by which the temporal stack area is implemented by use of a temporal stack register.

AS shown in FIG. 9, the address conversion unit 22 is located between the execution unit 21 and the main memory unit 23. The address conversion unit 22 converts addresses between the logical address used by the execution unit 21 and the physical address of the main memory unit 23. Further, the temporal stack register 17 is connected to the address conversion unit 22. The address conversion unit 22 includes a multiplexer 31, which allows an access destination to be switched between the main memory unit 23 and the temporal stack register 17.

At the time of stack overflow, the execution unit 21 sends a stack overflow notice to the address conversion unit 22. In response, the multiplexer 31 of the address conversion unit 22 switches the mapping destination from the main memory unit 23 to the temporal stack register 17, thereby allowing access to be made to the temporal stack area 13.

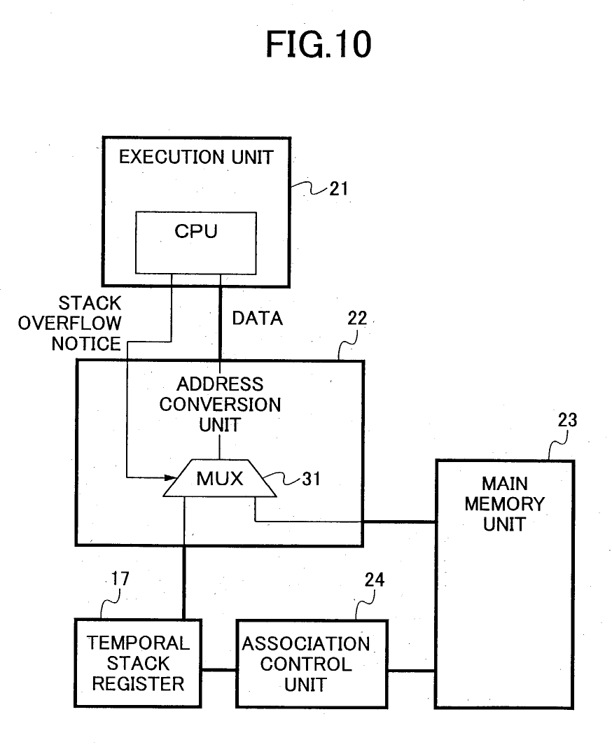

FIG. 10 is a block diagram showing a construction in which a cache is employed when the high-speed register serving as a temporal stack register has insufficient size. In FIG. 10, the same elements as those of FIG. 9 are referred to by the same numerals, and a description thereof will be omitted.

In the construction shown in FIG. 10, an association control unit 24 is newly provided between the temporal stack register 17 and the main memory unit 23 in addition to the construction shown in FIG. 9. The association control unit 24 allows the main memory unit 23 to be used as a cache memory. Data that are frequently accessed are stored in the temporal stack register 17 allowing high-speed access. When a cache miss occurs, access is made to the main memory unit 23. Such construction provides high-speed operations based on the use of the high-speed temporal stack register 17 while using only a decent memory size for the temporal stack register 17, without a need for provision of a maximum capacity needed for the temporal stack register 17. This achieves a construction that keeps proper balance between the costs, the circuit size, and performance.

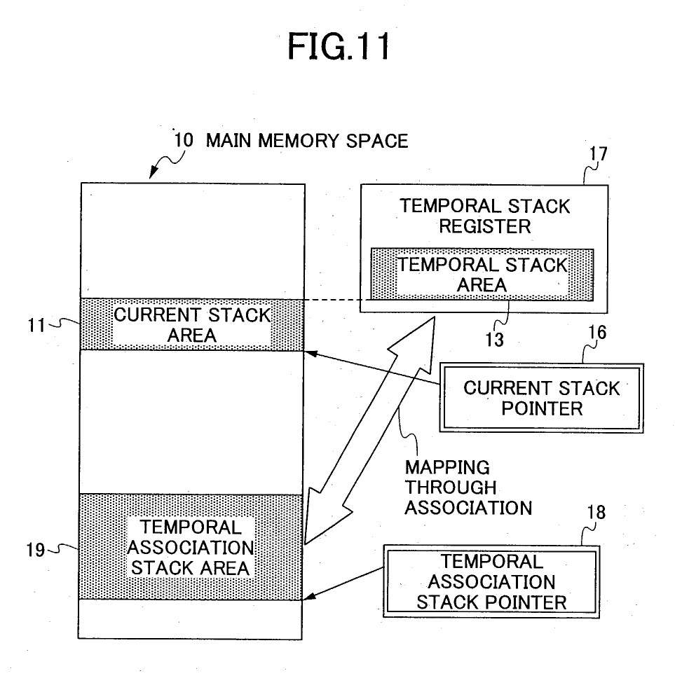

FIG. 11 is an illustrative drawing showing the memory space in which a temporal stack register is mapped through association control.

As shown in FIG. 11, the current stack pointer 16 stores a pointer that points to the current stack area 11 (i.e., the address of the current stack area 11), and a temporal association stack pointer 18 stores a pointer that points to a temporal association stack area 19 (i.e., the address of the temporal association stack area 19.

With this provision, it is possible to freely move the temporal association stack area 19 in the main memory space 10 according to the system needs. Further, the position of the current stack area 11 in the main memory space 10 can be changed as necessary by changing the pointer stored in the current stack pointer 16.

Further, the present invention is not limited to these embodiments, but various variations and modifications may be made without departing from the scope of the present invention.

What is claimed is:

1. A method of controlling stacks, comprising:
providing a temporal stack area in advance in a predetermined memory area;
allocating the temporal stack area as a continuation of a current stack area in response to detection of overflow of the current stack area in main memory space; and
executing a stack expansion process with respect to the current stack area by setting aside a new stack area by use of the temporal stack area as a work area.

2. The method as claimed in claim 1, further comprising a step of terminating the allocation of the temporal stack area as said continuation of the current stack area when the stack expansion process comes to an end.

3. The method as claimed in claim 1 wherein said step of providing a temporal stack area provides the temporal stack area at a predetermined address within the main memory space.

4. The method as claimed in claim 1, wherein said step of providing a temporal stack area includes the steps of:
providing the temporal stack area within the main memory space; and
providing an address pointer that points to the temporal stack area.

5. The method as claimed in claim 1, further comprising a step of providing an address pointer that points to the current stack area.

6. The method as claimed in claim 1 wherein said step of providing a temporal stack area provides the temporal stack area in a high-speed register that is different from a memory device providing the main memory space.

7. An information processing apparatus, comprising:
a main memory unit which provides main memory space;
an execution unit which executes a process by using a current stack area provided in the main memory space; and
an address conversion unit which allocates a temporal stack area as a continuation of the current stack area in response to detection of overflow by said execution unit when the overflow occurs with respect to the current stack area,
wherein said execution unit uses the temporal stack area as a work area in order to set aside a new stack area by carrying out a stack expansion process with respect to the current stack area.

8. The information processing apparatus as claimed in claim 7, wherein the temporal stack area is provided at a predetermined address in the main memory space.

9. The information processing apparatus as claimed in claim 7, further comprising a temporal stack register in which the temporal stack area is provided.

10. The information processing apparatus as claimed in claim 9, further comprising an association control unit which is situated between said temporal stack register and said main memory unit.

11. The information processing apparatus as claimed in claim 10, wherein said association control unit allows said temporal stack register to work as a cache memory that stores therein a frequently accessed portion of the temporal stack area whereas an entirety of the temporal stack area is stored in the main memory unit.
